(19) United States
(12) Patent Application Publication
(10) Pub. No.: US 2021/0374440 A1
(43) Pub. Date: Dec. 2, 2021

(54) ON-ROAD OBSTACLE DETECTION DEVICE, ON-ROAD OBSTACLE DETECTION METHOD, AND RECORDING MEDIUM

(71) Applicant: TOYOTA JIDOSHA KABUSHIKI KAISHA, Toyota-shi (JP)

(72) Inventor: Masao YAMANAKA, Chiyoda-ku (JP)

(73) Assignee: TOYOTA JIDOSHA KABUSHIKI KAISHA, Toyota-shi (JP)

(21) Appl. No.: 17/215,411

(22) Filed: Mar. 29, 2021

(30) Foreign Application Priority Data
May 27, 2020 (JP) 2020-092676

(51) Int. Cl. G06K 9/00; G06K 9/62; G06T 7/73

(52) U.S. Cl. CPC G06K 9/00805; G06T 2207/30261; G06T 7/73; G06K 9/6265

(57) ABSTRACT

An on-road obstacle detection device that includes: a memory; and a processor, the processor being connected to the memory and being configured to: assign a semantic label to each pixel in an image using a first discriminator that has been pre-trained using images in which an on-road obstacle is not present; and detect an on-road obstacle based on a probability density of the semantic label assigned.

### CROSS-REFERENCE TO RELATED APPLICATION

This application is based on and claims priority under 35 USC 119 from Japanese Patent Application No. 2020-092676 filed on May 27, 2020, the disclosure of which is incorporated by reference herein.

### BACKGROUND

### Technical Field

The present disclosure relates to an on-road obstacle detection device, an on-road obstacle detection method, and a recording medium recorded with an on-road obstacle detection program.

### Related Art

In Real Time Small Obstacle Detection on Highways Using Compressive RBM Road Reconstruction (Creusot et al., Intelligent Vehicles Symposium, 2015), a Restricted Boltzmann Machine (RBM) is trained using image patches for a normal road. In cases in which no on-road obstacles are present in an image patch, the RBM is capable of performing reconstruction. However, the RBM is unable to perform reconstruction in cases in which an on-road obstacle is present, resulting in a large difference (anomaly) between the input and the output of the RBM in cases in which reconstruction cannot be performed. By setting a suitable threshold for the size of the anomaly, on-road obstacles can accordingly be detected.

In reality, however, onboard images include many objects that while not being road are also not on-road obstacles, i.e. are objects other than on-road-obstacles such as vehicles, road signs, and man-made structures. Since objects that cannot be reconstructed by the RBM include such non-on-road-obstacle objects, these non-on-road-obstacle objects are mistakenly detected as on-road obstacles. There is accordingly room for improvement with respect to the accurate detection of on-road obstacles.

### SUMMARY

An aspect of the present disclosure is an on-road obstacle detection device that includes: a memory; and a processor, the processor being connected to the memory and being configured to: assign a semantic label to each pixel in an image using a first discriminator that has been pre-trained using images in which an on-road obstacle is not present; and detect an on-road obstacle based on a probability density of the semantic label assigned.

### BRIEF DESCRIPTION OF DRAWINGS

FIG. 1 is a block diagram illustrating an example of configuration of an on-road obstacle detection device according to a first exemplary embodiment.

FIG. 2 is a diagram to explain reconstruction of a semantically labelled image from a semantically labelled image.

FIG. 3 is a flowchart illustrating an example of a flow of processing performed by an on-road obstacle detection device according to the first exemplary embodiment.

FIG. 4 illustrates an example of an input image, a semantically labelled image, a reconstructed image, and a difference image in which no on-road obstacles are present, and an example of an input image, a semantically labelled image, a reconstructed image, and a difference image in which an on-road obstacle is present.

FIG. 5 is a block diagram illustrating an example of configuration of an on-road obstacle detection device according to a second exemplary embodiment.

FIG. 6 is a flowchart illustrating an example of a flow of processing performed by an on-road obstacle detection device according to the second exemplary embodiment.

FIG. 7 is a block diagram illustrating an example of hardware configuration of an on-road obstacle detection device.

### DESCRIPTION OF EMBODIMENTS

Detailed explanation follows regarding exemplary embodiments, with reference to the drawings. The following explanation describes examples of on-road obstacle detection devices that detect on-road obstacles in images captured by an onboard camera installed in a vehicle.

### First Exemplary Embodiment

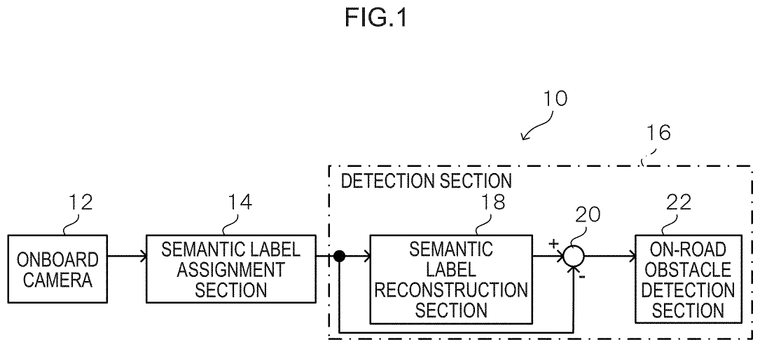

Explanation follows regarding an on-road obstacle detection device according to a first exemplary embodiment. FIG. 1 is a block diagram illustrating configuration of the on-road obstacle detection device according to the first exemplary embodiment.

As illustrated in FIG. 1, an on-road obstacle detection device 10 according to the present exemplary embodiment includes an onboard camera 12, a semantic label assignment section 14 corresponding to an assignment section, and a detection section 16. Specifically, the detection section 16 includes a semantic label reconstruction section 18, a comparison section 20, and an on-road obstacle detection section 22.

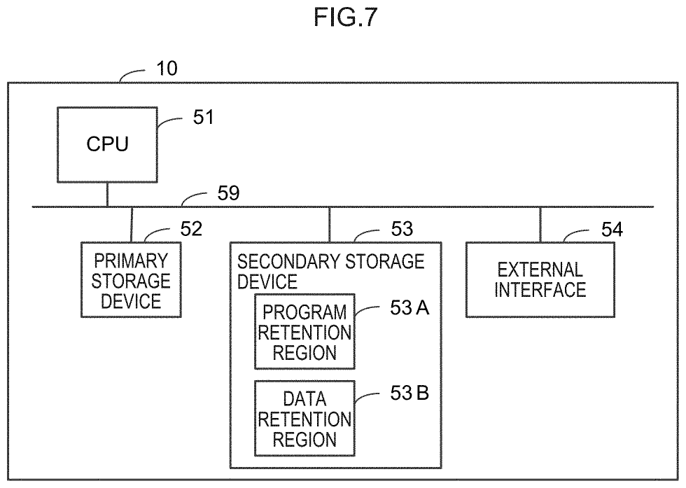

FIG. 7 illustrates an example of hardware configuration of the on-road obstacle detection device 10. In the example illustrated in FIG. 7, the on-road obstacle detection device 10 includes a central processing unit (CPU) 51, a primary storage device 52, a secondary storage device 53, and an external interface 54.

The CPU 51 is an example of a processor configured by hardware. The CPU 51, the primary storage device 52, the secondary storage device 53, and the external interface 54 are connected together through a bus 59. The CPU 51 may be configured by a single processor, or may be configured by plural processors. A graphics processing unit (GPU) or the like may be employed instead of the CPU 51.

The primary storage device 52 is configured by volatile memory such as random access memory (RAM). The secondary storage device 53 is configured by non-volatile memory such as a hard disk drive (HDD) or a solid state drive (SSD).

The secondary storage device 53 includes a program retention region 53A and a data retention region 53B. As an example, the program retention region 53A retains a program such as an on-road obstacle detection program. The data retention region 53B may for example function as a temporary storage device that temporarily retains intermediate data generated during execution of the on-road obstacle detection program.

The CPU 51 reads the on-road obstacle detection program from the program retention region 53A and expands this program in the primary storage device 52. By loading and executing the on-road obstacle detection program, the CPU 51 functions as the semantic label assignment section 14 and the detection section 16, namely the semantic label reconstruction section 18, the comparison section 20, and the on-road obstacle detection section 22, and performs on-road obstacle detection.

External devices are connected to the external interface 54, and the external interface 54 oversees the exchange of various information between the external devices and the CPU 51. For example, the onboard camera 12 is connected to the external interface 54. The onboard camera 12 may be built into the on-road obstacle detection device 10.

The onboard camera 12 is installed in the vehicle so as to image the vehicle surroundings, for example ahead of the vehicle, and outputs image information representing captured images to the semantic label assignment section 14.

The semantic label assignment section 14 uses a pre-trained discriminator to assign a semantic label to each pixel in an image captured by the onboard camera 12, and thus generate a semantically labelled image that is segmented into semantic regions. The discriminator employed by the semantic label assignment section 14 corresponds to a first discriminator. This discriminator is trained using supervised learning in which images of normal travel environments in which on-road obstacles are not present are gathered, and semantic labels (such as road, vehicle, and building) are assigned in the gathered images. Namely, the discriminator is trained using only images of normal travel environments, and images in which on-road obstacles are present are not employed. Examples of supervised learning include convolutional neural networks (CNN), recurrent neural networks (RNN), and conditional random fields (CRF). Examples of methods that may be applied as the method for segmentation into semantic regions include semantic segmentation (SS), this being a typical semantic region segmentation method, and the method described in ICNet for Real-Time Semantic Segmentation on High-Resolution Images (H. Zhao et al., ECCV 2018).

The detection section 16 detects an on-road obstacle based on a probability density of the semantic labels assigned by the semantic label assignment section 14. As described above, the detection section 16 includes the functionality of the semantic label reconstruction section 18, the comparison section 20, and the on-road obstacle detection section 22.

The semantic label reconstruction section 18 inputs a preset patch of the semantically labelled image that has been assigned with semantic labels by the semantic label assignment section 14 into a discriminator that has been pre-trained with statistical distributions of semantic labels using images in which on-road obstacles are not present. The semantic label reconstruction section 18 thereby generates a reconstructed image by reconstructing a semantically labelled image corresponding to the patch.

The discriminator employed by the semantic label reconstruction section 18 corresponds to a second discriminator, and, for example, a variational autoencoder (VAE) may be employed, and the VAE trained with input of patches in semantically labelled images. Note that instead of employing a 3 channel RGB input, the VAE is trained with input of N-channel semantically labelled images of probability distributions relating to semantic labels (wherein N is the number of labels). In the VAE an N-channel probability density is reconstructed from the probability densities for the N channels.

Note that with regard to the VAE input x, an approach may be adopted in which probabilities p_{i,j} are arranged as illustrated in (A) below, with probability p_{i,j} being the probability for an i^{th} semantic label in a j^{th} patch, and plural VAEs trained.

x₁=(p_{1,1},p_{1,2} . . . p_{1,L×L}),x₂=(p_{2,1},p_{2,2} . . . p_{2,L×L}), . . . x_{N}=(p_{N,1′},p_{N,2} . . . p_{N,L×L}) (A)

Alternatively, an approach may be adopted in which probabilities p_{i,j} are arranged as illustrated in (B) below, with probability p_{i,j} being the probability for the j^{th} patch considering all semantic labels, and a single VAE trained.

x=(p_{1,1},p_{2,1} . . . p_{N,1},p_{1,2},p_{2,2} . . . p_{N,2} . . . p_{1,L×L},p_{2,L×L} . . . p_{N,L×L}) (B)

Moreover, in the VAE, parameters (ϕ, θ) are trained so as to maximize a variation lower limit L (X, z) as represented by Equation (1) below. The first term represents a regularizing term to convert a distribution p_{θ} (z) of z to a normal distribution N (0, I) in KL divergence, and the second term represents a reconstruction error between an encoder q_{ϕ} (z|X) and a decoder p₀ (X|z) for reconstruction loss.

L(X,z)=−D_{KL}[q_{ϕ}(z|X)∥p_{θ}(z)]E_{qϕ(Z|X)}[log p_{θ}(X|z)] (1)

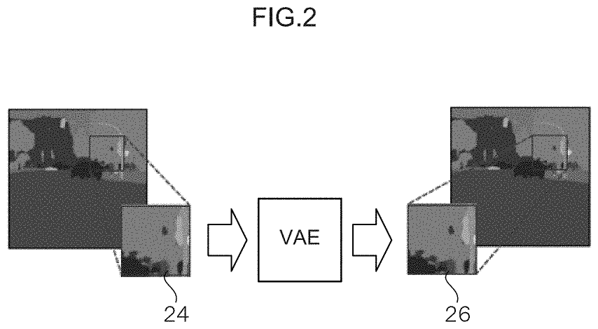

As illustrated in FIG. 2, a patch 24 of a preset size in an N-channel semantically labelled image is input to the VAE by the semantic label reconstruction section 18 to reconstruct the patch in the semantically labelled image so as to generate a reconstructed patch 26. Patches 24 are employed to sequentially generate reconstructed patches 26 for the entire area of the semantically labelled image so as to generate a reconstructed image. Thus, in the case of a semantically labelled image of a normal travel environment, a semantically labelled image can be reconstructed from the semantically labelled image. However, semantic label reconstruction will fail for any patch of a semantically labelled image representing an abnormal travel environment in which an on-road obstacle is present. Note that an autoencoder (AE) may be employed instead of a variational autoencoder.

The comparison section 20 compares the semantically labelled image assigned with semantic labels by the semantic label assignment section 14 against the reconstructed image reconstructed by the semantic label reconstruction section 18. In the present exemplary embodiment, the comparison section 20 computes a difference between the input semantically labelled image and the reconstructed image.

Based on the comparison result of the comparison section 20, the on-road obstacle detection section 22 detects any location where the difference is a preset threshold or greater as being an on-road obstacle.

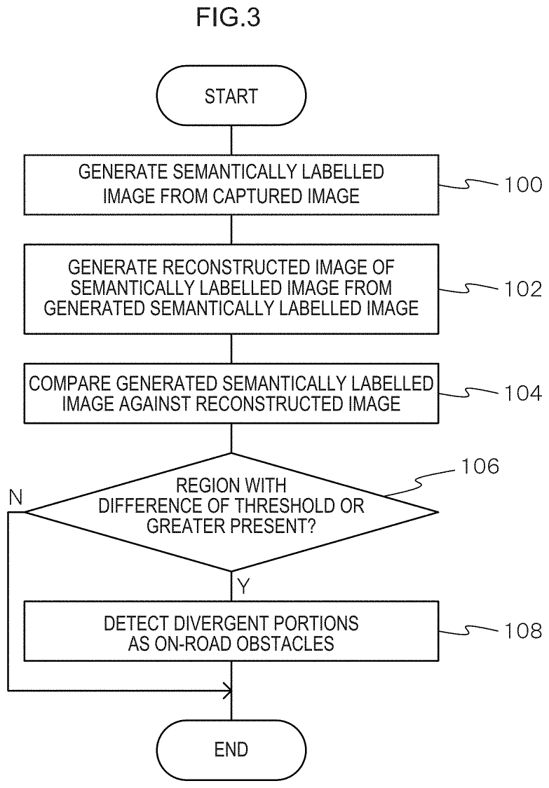

Next, explanation follows regarding processing performed by the on-road obstacle detection device 10 according to the present exemplary embodiment configured as described above. FIG. 3 is a flowchart illustrating an example of a flow of processing performed by the on-road obstacle detection device 10 according to the present exemplary embodiment.

At step 100, the semantic label assignment section 14 generates a semantically labelled image from an evaluation target captured image captured by the onboard camera 12, and processing transitions to step 102. Namely, using a discriminator that has been pre-trained using only images of normal travel environments, semantic labels are assigned to each of the pixels in the captured image, thereby generating a semantically labelled image segmented into semantic regions.

At step 102, the semantic label reconstruction section 18 generates a reconstructed image of the semantically labelled image from the generated semantically labelled image, and processing transitions to step 104. Namely, a preset patch of the semantically labelled image assigned with semantic labels by the semantic label assignment section 14 is input to the discriminator pre-trained with statistical distributions of semantic labels using only images in which on-road obstacles are not present. A reconstructed image is thereby generated by reconstructing a semantically labelled image corresponding to the patch.

At step 104, the comparison section 20 compares the generated semantically labelled image against the reconstructed image, and processing transitions to step 106. As previously described, the difference between the semantically labelled image and the reconstructed image is computed in the present exemplary embodiment.

At step 106, the on-road obstacle detection section 22 determines whether or not there is a region for which the difference between the semantically labelled image and the reconstructed image is the preset threshold or greater. In cases in which this determination is affirmative, processing transitions to step 108. In cases in which this determination is negative, the processing routine is ended.

At step 108, the on-road obstacle detection section 22 detects divergent portions where the difference between the semantically labelled image and the reconstructed image is the threshold or greater as an on-road obstacle, and the processing routine is ended.

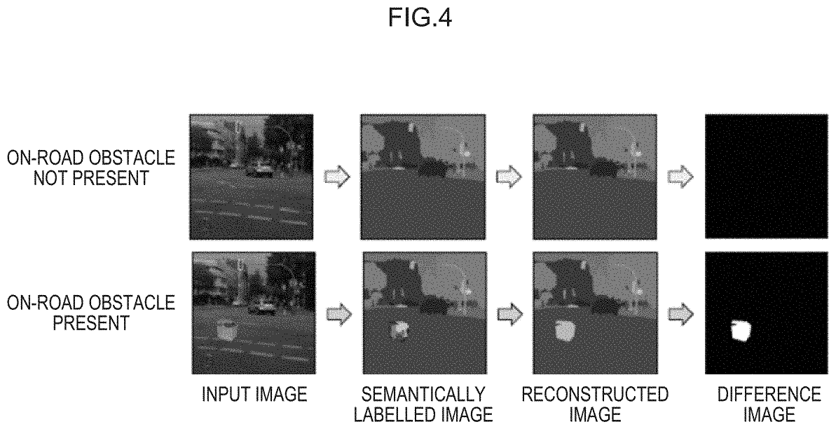

In the on-road obstacle detection device 10 according to the present exemplary embodiment, in cases in which, for example, the input image is a captured image in which no on-road obstacles are present, then a semantically labelled image, a reconstructed image, and a difference image such as those illustrated in the upper row in FIG. 4 will be generated. In such cases, since no on-road obstacles are present, the difference image indicating the difference between the semantically labelled image and the reconstructed image is an empty state (substantially zero) as illustrated in the upper row in FIG. 4.

However, in cases in which the input image is a captured image including an on-road obstacle, a semantically labelled image, a reconstructed image, and a difference image such as those illustrated in the lower row in FIG. 4 will be generated. In such cases, due to the presence of the on-road obstacle, a semantic label assignment failure occurs when generating the semantically labelled image. Moreover, there is a non-reconstructable region at a region corresponding to the on-road obstacle in the reconstructed image. The non-reconstructable region therefore appears as a divergent region in the difference image configured by the differences between the semantically labelled image and the reconstructed image, as illustrated in the lower row in FIG. 4, thereby enabling this region to be detected as an on-road obstacle. Note that FIG. 4 illustrates both an example of an input image, a semantically labelled image, a reconstructed image, and a difference image in a case in which no on-road obstacle is present, as well as an example of an input image, a semantically labelled image, a reconstructed image, and a difference image in a case in which an on-road obstacle is present.

Thus, in the present exemplary embodiment, there is a high likelihood of an on-road obstacle being present in a region that cannot be reconstructed from a semantically labelled image, and since a large divergence emerges when the semantically labelled image and the reconstructed image are compared, this enables such divergent portions to be detected as on-road obstacles. This enables accurate detection of on-road obstacles, even in cases in which non-on-road-obstacle objects are present in an image.

### Second Exemplary Embodiment

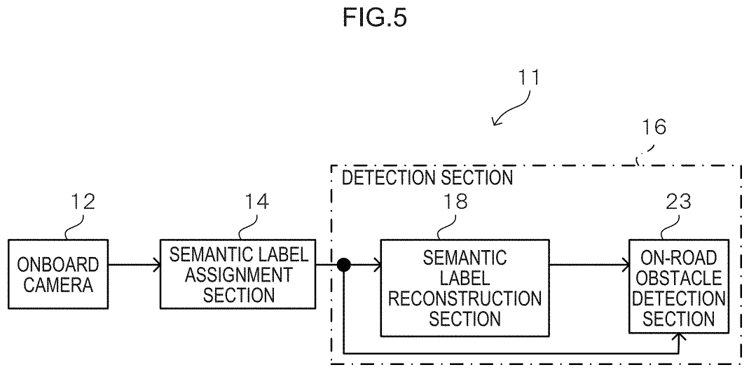

Next, explanation follows regarding an on-road obstacle detection device 11 according to a second exemplary embodiment. FIG. 5 is a block diagram illustrating configuration of the on-road obstacle detection device 11 according to the second exemplary embodiment. Note that configuration similar to that illustrated in FIG. 1 is allocated the same reference numerals, and explanation thereof is simplified.

In the first exemplary embodiment, the difference between the semantically labelled image and the reconstructed image is computed in order to detect on-road obstacles. In contrast thereto, in the present exemplary embodiment a region where reconstruction error in a reconstructed image is a threshold or greater is detected as an on-road obstacle, without computing the difference between the semantically labelled image and the reconstructed image.

As illustrated in FIG. 5, the on-road obstacle detection device 10 according to the present exemplary embodiment includes the onboard camera 12, the semantic label assignment section 14, and the detection section 16 similarly to in the first exemplary embodiment. However, the detection section 16 includes the semantic label reconstruction section 18 and an on-road obstacle detection section 23. Namely, the comparison section 20 of the first exemplary embodiment is omitted, and the on-road obstacle detection section 23 detects on-road obstacles based on the reconstruction error in a reconstructed image.

Similarly to in the first exemplary embodiment, the onboard camera 12 is installed in the vehicle so as to image the vehicle surroundings, for example, ahead of the vehicle, and outputs image information representing captured images to the semantic label assignment section 14.

The semantic label assignment section 14 uses a pre-trained discriminator to assign a semantic label to each pixel in an image captured by the onboard camera 12, and thus generates a semantically labelled image that is segmented into semantic regions.

The semantic label reconstruction section 18 inputs a preset patch of the semantically labelled image assigned with semantic labels by the semantic label assignment section 14 into a discriminator pre-trained with statistical distributions of semantic labels using images in which on-road obstacles are not present. The semantic label reconstruction section 18 thereby generates a reconstructed image by reconstructing a semantically labelled image corresponding to the patch.

The on-road obstacle detection section 23 computes the reconstruction error in the reconstructed image, and in cases in which a region is present where the reconstruction error is a preset threshold or greater, the threshold or greater region is detected as an on-road obstacle. Specifically, determination is made as to whether or not there is a region in which the reconstruction error represented by the second term of Equation (1) in the first exemplary embodiment is the preset threshold or greater, and any such threshold or greater regions are detected as being on-road obstacles.

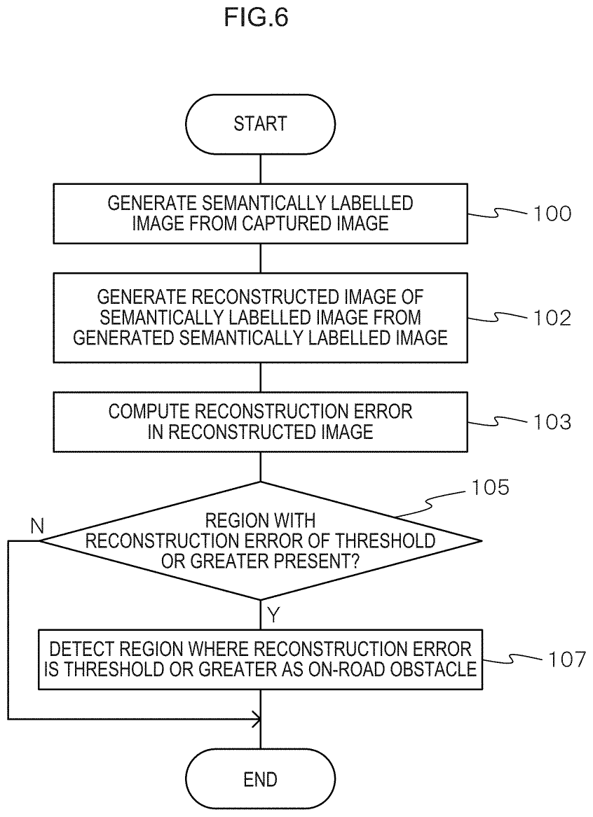

Next, specific explanation follows regarding processing performed by the on-road obstacle detection device 11 according to the present exemplary embodiment configured as described above. FIG. 6 is a flowchart illustrating an example of a flow of processing performed by the on-road obstacle detection device 11 according to the present exemplary embodiment. Note that processing that matches that in FIG. 3 is allocated the same numerals in the following explanation.

At step 100, the semantic label assignment section 14 generates a semantically labelled image from an evaluation target captured image captured by the onboard camera 12, and processing transitions to step 102. Namely, using a discriminator that has been pre-trained using only images of normal travel environments, semantic labels are assigned to each of the pixels in the captured image, thereby generating a semantically labelled image segmented into semantic regions.

At step 102, the semantic label reconstruction section 18 generates a reconstructed image of the semantically labelled image from the generated semantically labelled image, and processing transitions to step 103. Namely, a preset patch of the semantically labelled image that has been assigned with semantic labels by the semantic label assignment section 14 is input to the discriminator that has been pre-trained with statistical distributions of semantic labels using only images in which on-road obstacles are not present. A reconstructed image is thereby generated by reconstructing a semantically labelled image corresponding to the patch.

At step 103, the on-road obstacle detection section 23 computes the reconstruction error of the reconstructed image, and processing transitions to step 105. Namely, the reconstruction error represented by the second term of Equation (1) previously described is computed.

At step 105, the on-road obstacle detection section 23 determines whether or not there is a region for which the reconstruction error in the reconstructed image is the preset threshold or greater. In cases in which this determination is affirmative, processing transitions to step 107. In cases in which this determination is negative, the processing routine is ended.

At step 107, the on-road obstacle detection section 23 detects the regions where the reconstruction error in the reconstructed image is the threshold or greater as being on-road obstacles, and the processing routine is ended.

Thus, in the present exemplary embodiment, when reconstructing a semantically labelled image from the input semantically labelled image, since there is a high likelihood that reconstruction will fail where an on-road obstacle is present, a region where there is a large reconstruction error of the threshold or greater in the reconstructed image can be detected as an on-road obstacle. This enables on-road obstacles to be accurately detected, even in cases in which non-on-road-obstacle objects are present in an image.

Note that although the comparison is performed by computing the difference between a semantically labelled image and a reconstructed image in the first exemplary embodiment, there is no limitation to a simple difference. The difference may be computed by multiplication of respective coefficients or functions. Alternatively, instead of the difference, a reconstruction ratio or the like of the reconstructed image with respect to the semantically labelled image may be computed.

Although the on-road obstacle detection device 10, 11 is configured as a single device in each of the above exemplary embodiments, there is no limitation thereto. For example, the onboard camera 12 may be installed in a vehicle, and the semantic label assignment section 14 and the detection section 16 may be included in a cloud server that is connected to the vehicle by wireless communication. In such cases, the respective functionality of the semantic label assignment section 14 and the detection section 16 may be provided in respective function-specific cloud servers.

Note that although the processing performed by the respective sections of the on-road obstacle detection device 10, 11 in each of the above exemplary embodiments is explained as software processing performed by executing a program, there is no limitation thereto. For example, the processing may be performed using hardware such as an application specific integrated circuit (ASIC) or a field-programmable gate array (FPGA). Alternatively, the processing may be performed using a combination of both software and hardware. In the case of software processing, the program may be stored and distributed on various non-transitory storage media, such as a DVD or the like.

The present disclosure is not limited to the above description, and various other modifications may be implemented within a range not departing from the spirit of the present disclosure.

An object of the present disclosure is to enable accurate detection of on-road obstacles, even in cases in which non-on-road-obstacle objects are present in an image.

A first aspect of the present disclosure is an on-road obstacle detection device that includes: a memory; and a processor, the processor being connected to the memory and being configured to: assign a semantic label to each pixel in an image using a first discriminator that has been pre-trained using images in which an on-road obstacle is not present; and detect an on-road obstacle based on a probability density of the semantic label assigned.

According to the first aspect, a semantic label is assigned to each pixel in an image using the first discriminator that has been pre-trained using images in which an on-road obstacle is not present.

The on-road obstacle is detected based on the probability density of the assigned semantic label. Detecting the on-road obstacle based on the probability density of the semantic label in this manner enables accurate detection of on-road obstacles even in cases in which non-on-road-obstacle objects are present.

A second aspect of the present disclosure is the on-road obstacle detection device of the first aspect, wherein the processor is further configured to: input a preset patch of a semantically labelled image, that has been assigned with the semantic label, into a second discriminator that has been pre-trained with statistical distributions of semantic labels using images in which an on-road obstacle is not present, reconstruct a semantically labelled image corresponding to the patch, and detect an on-road obstacle based on the reconstructed image that has been reconstructed. Accordingly, semantic label assignment failure will occur in a region in which an on-road obstacle is present, and semantic label assignment failure likewise occurs during reconstruction, thus enabling an anomalous location in the reconstructed image to be detected as an on-road obstacle.

A third aspect of the present disclosure is the on-road obstacle detection device of the second aspect, wherein the processor is further configured to detect an on-road obstacle by comparing the semantically labelled image against the reconstructed image. Since it is difficult to reconstruct a region in which an on-road obstacle is present, an on-road obstacle can be detected by comparing the semantically labelled image against the reconstructed image.

A fourth aspect of the present disclosure is the on-road obstacle detection device of the third aspect, wherein a location where a difference between the semantically labelled image and the reconstructed image is a preset threshold or greater is detected as an on-road obstacle. This enables the location where the divergence between the semantically labelled image and the reconstructed image is large to be detected as an on-road obstacle.

A fifth aspect of the present disclosure is the on-road obstacle detection device of the second aspect, wherein the processor is further configured to detect a region where reconstruction error in the reconstructed image is a preset threshold or greater as an on-road obstacle. This enables the on-road obstacle to be detected from the reconstructed image.

The first to the fifth aspects can be provided in forms of a method or a non-transitory computer readable recording medium.

The present disclosure enables accurate detection of on-road obstacles, even in cases in which non-on-road-obstacle objects are present in an image.

1. An on-road obstacle detection device comprising:
a memory; and
a processor, the processor being connected to the memory and being configured to:
assign a semantic label to each pixel in an image using a first discriminator that has been pre-trained using images in which an on-road obstacle is not present; and
detect an on-road obstacle based on a probability density of the semantic label assigned.

2. The on-road obstacle detection device of claim 1, wherein the processor is further configured to:
input a preset patch of a semantically labelled image, that has been assigned with the semantic label, into a second discriminator that has been pre-trained with statistical distributions of semantic labels using images in which an on-road obstacle is not present,
reconstruct a semantically labelled image corresponding to the patch, and
detect an on-road obstacle based on the reconstructed image that has been reconstructed.

3. The on-road obstacle detection device of claim 2, wherein the processor is further configured to detect an on-road obstacle by comparing the semantically labelled image against the reconstructed image.

4. The on-road obstacle detection device of claim 3, wherein a location where a difference between the semantically labelled image and the reconstructed image is a preset threshold or greater is detected as an on-road obstacle.

5. The on-road obstacle detection device of claim 2, wherein the processor is further configured to detect a region where reconstruction error in the reconstructed image is a preset threshold or greater as an on-road obstacle.

6. An on-road obstacle detection method comprising:
by a processor,
assigning a semantic label to each pixel in an image using a first discriminator that has been pre-trained using images in which an on-road obstacle is not present; and
detecting an on-road obstacle based on a probability density of the assigned semantic label.

7. The on-road obstacle detection method of claim 6, further comprising:
inputting a preset patch of a semantically labelled image, that has been assigned with the semantic label, into a second discriminator that has been pre-trained with statistical distributions of semantic labels using images in which an on-road obstacle is not present,
reconstructing a semantically labelled image corresponding to the patch, and
detecting an on-road obstacle based on the reconstructed image that has been reconstructed.

8. The on-road obstacle detection method of claim 7, further comprising
detecting an on-road obstacle by comparing the semantically labelled image against the reconstructed image.

9. The on-road obstacle detection method of claim 8, wherein a location where a difference between the semantically labelled image and the reconstructed image is a preset threshold or greater is detected as an on-road obstacle.

10. The on-road obstacle detection method of claim 7, further comprising
detecting a region where reconstruction error in the reconstructed image is a preset threshold or greater as an on-road obstacle.

11. A non-transitory computer-readable recording medium that records a program that is executable by a computer to perform an on-road obstacle detection processing, the on-road obstacle detection processing comprising:
assigning a semantic label to each pixel in an image using a first discriminator that has been pre-trained using images in which an on-road obstacle is not present; and
detecting an on-road obstacle based on a probability density of the assigned semantic label.

12. The non-transitory computer-readable recording medium of claim 11, wherein the on-road obstacle detection processing further comprising:
inputting a preset patch of a semantically labelled image, that has been assigned with the semantic label, into a second discriminator that has been pre-trained with statistical distributions of semantic labels using images in which an on-road obstacle is not present,
reconstructing a semantically labelled image corresponding to the patch, and
detecting an on-road obstacle based on the reconstructed image that has been reconstructed.

13. The non-transitory computer-readable recording medium of claim 12, wherein the on-road obstacle detection processing further comprising
detecting an on-road obstacle by comparing the semantically labelled image against the reconstructed image.

14. The non-transitory computer-readable recording medium of claim 13, wherein a location where a difference between the semantically labelled image and the reconstructed image is a preset threshold or greater is detected as an on-road obstacle.

15. The non-transitory computer-readable recording medium of claim 12, wherein the on-road obstacle detection processing, further comprising
detecting a region where reconstruction error in the reconstructed image is a preset threshold or greater as an on-road obstacle.
